(19) United States
(12) Patent Application Publication
(10) Pub. No.: US 2014/0032318 A1
(43) Pub. Date: Jan. 30, 2014

(54) CREATING, SHARING, AND MONETIZING ONLINE DIGITAL CONTENT HIGHLIGHTS

(71) Applicant: Michael Hopwood, Jericho, VT (US)

(72) Inventor: Michael Hopwood, Jericho, VT (US)

(21) Appl. No.: 12/121,998

(22) Filed: May 16, 2008

(51) Int. Cl. G06Q 30/00

(52) U.S. Cl. 705/14.53

(57) ABSTRACT

In one example embodiment, a system and method is shown as including receiving a segment request including a reference to a segment of a content item. The system and method may also include retrieving an advertisement to be associated with the segment. Further, the system and method may include associating the segment and the advertisement to form a derivative content item. Additionally, the system and method may include transmitting the derivative content item. A system and method is also shown that includes receive count data including a number of times an advertisement included in a derivative content item has been accessed, the advertisement being combined with a segment of a content item to form the derivative content item. This system and method may also include calculating a payment amount based on the count data. Moreover, the system and method may include transmitting a payment instruction including the payment amount.

### CROSS REFERENCE TO RELATED APPLICATIONS

This is a United States Patent Application that is related to U.S. patent application Ser. No. 11/820,586 entitled “COMMUNITY BASED DIGITAL CONTENT AUDITING AND STREAMING” that was filed on Jun. 19, 2007, and that is incorporated by reference in its entirety.

### COPYRIGHT

A portion of the disclosure of this document includes material subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright © 2008, Adobe Systems Incorporated. All Rights Reserved.

### TECHNICAL FIELD

The present application relates generally to the technical field of algorithms and programming and, in one specific example, to the generation of digital content.

### BACKGROUND

The streaming of digital content including video, audio, and audio/video content (collectively digital content) may use a number of different software applications, protocols, and devices. Digital content may include long-form content, where long-form content may be a movie, full length television program, full-length song, or other suitable piece of unshortened or uncondensed digital content. Long-form content may be a non-derivative work. These software applications may include media player applications such as Adobe Systems Inc.'s FLASH PLAYER™, Real Networks Corporation's REALPLAYER™, or Microsoft Corporations WINDOWS MEDIA PLAYER™. A media player application may also include a client engine associated with a browser application. Protocols used by these media player applications may include the Real Time Streaming Protocol (RTSP), a Hyper Text Transfer Protocol (HTTP), or some other suitable protocol. Devices using these media player applications and protocols may include computer systems, cell phones, Personal Digital Assistants (PDA), smart phones, or other suitable devices.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, used to generate a segment and advertisement associated with the segment.

FIG. 2 is a diagram of a system, according to an example embodiment, used to aggregate and serve a plurality of a metadata scripts.

FIG. 3 is diagram of a system, according to an example embodiment, illustrating the generation of count data and the crediting of a user for this count data.

FIG. 4 is a Graphical User Interface (GUI), according to an example embodiment, used to display the segment and advertisement.

FIG. 5 is a GUI, according to an example embodiment, used to generate a derivative content item using linked screen objects or widget.

FIG. 6 is a GUI, according to an example embodiment, that may be used to generate a derivative content item using an instruction set written as a script.

FIG. 7 is a diagram of a derivative content item, according to an example embodiment, and a scripting language representation thereof.

FIG. 8 is a diagram of a metadata script request, according to an example embodiment.

FIG. 9 is a diagram of a metadata script, according to an example embodiment.

FIG. 10 is a diagram of a segment request, according to an example embodiment.

FIG. 11 is a block diagram of a computer system, according to an example embodiment, used to generate a derivative content item.

FIG. 12 is a block diagram of a computer system, according to an example embodiment, used to transmit payment instructions.

FIG. 13 is flow chart illustrating the execution of a method, according to an example embodiment, to transmit a derivative content item.

FIG. 14 is a flow chart illustrating a method, according to an example embodiment, used to transmit payment instructions.

FIG. 15 is a tri-stream flowchart illustrating a method, according to an example embodiment, to generate the segment and advertisement.

FIG. 16 is a tri-stream flowchart illustrating a method, according to an example embodiment, used to generate a segment and advertisement, where the advertisement is based upon user provided user profile metadata.

FIG. 17 is a flow chart illustrating an operation, according to an example embodiment, that is executed to retrieve an advertisement using the segment identifier.

FIG. 18 is a flowchart illustrating an operation, according to an example embodiment, to combine the advertisement and segment as a derivative content item.

FIG. 19 is a dual-stream flowchart illustrating a method, according to an example embodiment, to generate a metadata script as a result of a metadata script request.

FIG. 20 is a flowchart illustrating the execution of an operation, according to an example embodiment, to retrieve a metadata script from a database based upon the metadata script request.

FIG. 21 is a flowchart illustrating the execution of an operation, according to an example embodiment, that may insert a permission into a metadata script.

FIG. 22 is a Relational Data Schema (RDS), according to an example embodiment.

FIG. 23 shows a diagrammatic representation of a machine in the example form of a computer system that executes a set of instructions to perform any one or more of the methodologies discussed herein.

### DETAILED DESCRIPTION

In the following description, for purposes of explanation, numerous specific details are set forth to provide a thorough understanding of an example embodiment of the present invention. It may be evident, however, to one skilled in the art that the present invention will be practiced without these specific details.

In some example embodiments, a system and method is shown that facilitates the streaming of segments of long-form audio, video, or audio/video content, where the streaming of this digital content is monetized in some manner. In one example embodiment, a metadata file is retrieved from a segment server. This metadata file may be written using an: eXtensible Markup Language (XML), Hyper Text Markup Language (HTML), ActionScript, Perl, JavaScript, VBScript, or some other suitable scripting language. The segment server may be a FLASH MEDIA SERVER™. This metadata file may be natively stored onto a device capable of using a media player application. Using the metadata file in conjunction with a media player application (e.g., a standalone player or a player plug-in to another presentation application such as a browser), the device may retrieve digital content from the segment server for playing. A scripting language may be used to implement the media player application. In some example embodiments, RTSP may be used to set up a session to stream digital content to the media player application. In other example embodiments, HTTP may be used to set up a session to retrieve the digital content.

Some example embodiments may include the monetization of a segment of long-form video through the use of advertising. In one example embodiment, the owner (e.g., a copyright owner) of a segment may license the use of one or more of their copyrights to a user of a media player application. This licensing may be in exchange for the right to provide an advertisement to the user of a media player application. The owner may select the type of advertisement to be associated with the segment. Associated may mean to be displayed and played before, during (e.g., as a banner ad) or after the segment within a GUI for a browser application. In some example embodiments, the user or owner of the media player application may receive some type of monetary compensation for the posting of the segment to a website.

In some example embodiments, the metadata file alone, or in conjunction with a scripting language file, may be used to virally distribute the segment. Virally or viral may refer to a digital content (e.g., a segment) that is distributed through the process of Internet sharing, via e-mail, IM messages, blogs, or media sharing websites. Various functionalities such as the “copy and paste” function associated with a web browser may be associated with the process of Internet sharing, via e-mail, IM messages, blogs, or media sharing websites. In one example case, a user may make the metadata file alone or in combination with a scripting language file available on a website. Third party users may be able to access (e.g., copy and paste) this metadata and/or script file into a development environment (e.g., a GUI with editing functionality associated therewith). This development environment may then be used to post the metadata and/or scripting file to a website for playing and use. Playing may include playing by a media player application embedded in a web page that is part of the website. In the case of viral distribution, the monetization of the segment may occur in the manner as illustrated above.

In some example embodiments, the segment may be a derivative content item (e.g., a derivative work) in the example form of a mashup. A mashup may be a digital media file including any combination of text, graphics, audio, video, and animation drawn from another digital media file to create a new work. In some example embodiments, live streamed digital content may be used to create a mashup. Live streamed digital content may include a concert or a dramatic play based upon which audio and video data is generated. Further, a mashup may be an integration of multi-sourced applications or content into a single offering. Additionally, a mashup may be a combination of digital content from one or more different sources into a single digital media file. A new work may be one or more segments derived from another digital media file. This digital media file may be long-form content. Additionally, this work may have advertisements associated with it. Further, this work may be a derivative work that may have certain copyrights associated with it.

### Example System

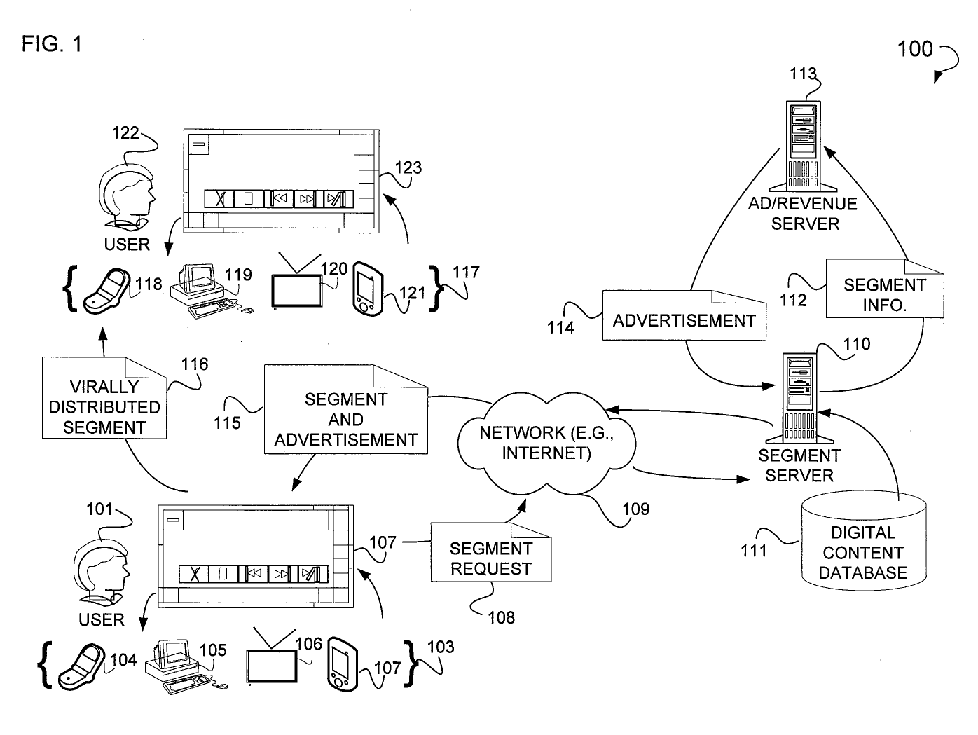

FIG. 1 is a diagram of an example system 100 used to generate a segment and advertisement associated with the segment (collectively segment and advertisement). Shown is a user 101 who, using one or more devices 103, generates a segment request 108. These one or more devices 103 may include a cell phone 104, a computer system 105, a television monitor 106, a PDA 107, or a smart phone (not shown). The user 101 may further use a GUI 107 that may be generated using the one or more devices 103. The GUI 107 may be a browser application that may include a client engine such as a FLASH™ engine, ACTIVE X™ engine, or an Asynchronous JavaScript and extensible Markup Language (XML) (AJAX) engine. Through using this GUI 107, the user 101 may generate a segment request 108 that that is transmitted by the one or more devices 103 across a network 109 to be received by a segment server 110. The one or more devices 103 may be operatively coupled to the segment server via a logical or physical connection. Operatively coupled to the segment server 110 may be a digital content database 111. This digital content database 111 may reside natively as part of the segment server 110, or may be managed and controlled by a further database server (not shown). Further, this digital content database 111 may include digital content as long-form content in the form of audio-video content, audio content, or some other suitable form of content.

In some example embodiments, an ad/revenue server 113 is operatively coupled to the segment server 110. This ad/revenue server 113 is operatively coupled via a Local Area Network (LAN), a Wide Area Network (WAN), or some other suitable physical or logical connection. The segment server 110 transmits segment information 112 to be received by the ad/revenue server 113. Using this segment information 112, the ad/revenue server 113 may look up a particular advertisement 114 to be associated with the requested segment (e.g., the segment requested via the segment request 108). The advertisement 114 may be transmitted by the ad/revenue server 113 to be received by the segment server 110. The segment server 110 may then associate the advertisement 114 with a segment to generate a segment and advertisement data 115 that is then transmitted across the network 109 to be received by the one or more devices 103. This segment and advertisement data 115 may be regarded as a derivative content item (e.g., a mashup). The segment and advertisement data 115 may be displayed within the GUI 107. The segment and advertisement data 115 may be viewed by the user 101 using the GUI 107. In some example embodiments, the advertisement 114 may be streamed as a banner ad by the segment server 110 to be displayed in the GUI 107 (see e.g., sub-frame 401 below). The aforementioned RTSP may be used to stream this banner ad.

In some example embodiments, the segment request 108 may be an RTSP-based message or an HTTP-based message. Further, the segment and advertisement data 115 may be MPEG, H.261-H.264, or VP6 encoded digital content that may be retrieved using RTSP or HTTP. Additionally, the segment information 112 may be transmitted using a Secure Hypertext Transfer Protocol (HTTPS), and the advertisement 114 may be returned to the segment server using HTTPS.

In some example embodiments, a virally distributed segment 116 may be received by a user 122 using one or more devices 117. These one or more devices 117 may include a cell phone 118, a computer system 119, television monitor 120, a PDA 121 or, a smart phone (not shown). The user 122 may use a GUI 123 that is executed through using the one or more devices 117. The GUI 123 may be a browser application that may include a client side engine such as a FLASH™ engine, ACTIVE X™ engine, or AJAX engine. The virally distributed segment 116 may include some type of instruction set coded in ActionScript, JavaScript, VBScript, or some other suitable scripting language. This instruction set may then be retrieved by the user 122 and executed using the GUI 123 and the functionality associated therewith. For example, the user 122 may copy the instructions included in the virally distributed segment 116 using some type of input device (e.g., a mouse, light pen, or other suitable input devices) from a webpage generated and displayed by the user 101. Once copied, this instruction set may then be executed and instructions transmitted (e.g., through executing a paste command associated with the GUI 123) across a network (e.g., the Internet, a LAN, a WAN or other suitable network and associated topology) to be received by the one or more devices 117 and ultimately executed by the one or more devices 117 as a script. The virally distributed segment 116 may include an instruction set that allows the user 122 to generate the previously illustrated segment request 108. The user 122 may use the one or more devices 117 in combination with the GUI 123 to generate the segment request 108. As previously shown, the segment request 108 may be transmitted across a network 109 to be received by the segment server 110. In some example embodiments, the user 122 may generate and transmit the segment request 108 using the one or more devices 117.

In some example embodiments, an ad/revenue server 113 is operatively coupled to the one or more devices 103 or 117, and may transmit the advertisement 114 directly to these one or more devices 103 or 117. This transmission may occur over the network 109, and may be synchronized with the serving of a segment by the segment server 110 to the one or more devices 103 or 117. Synchronization may include the providing of the advertisement 114 prior to the serving of the segment. In some example embodiments, the advertisement 114 may be streamed to the GUI 107 or GUI 123 as a banner ad (see e.g., sub-frame 401 below). RTSP may be used to stream this banner ad.

In some example embodiments, the segment request 108 may include data identifying a segment, and/or may include metadata identifying and defining a user profile. A segment may be identified via a unique identifier value. Metadata identifying and defining a user profile may include XML encoded data that describes user demographic information (e.g., a user's age, gender, or physical location, education), the number of persons to which the user is related, and other demographic information commonly found on a social networking page.

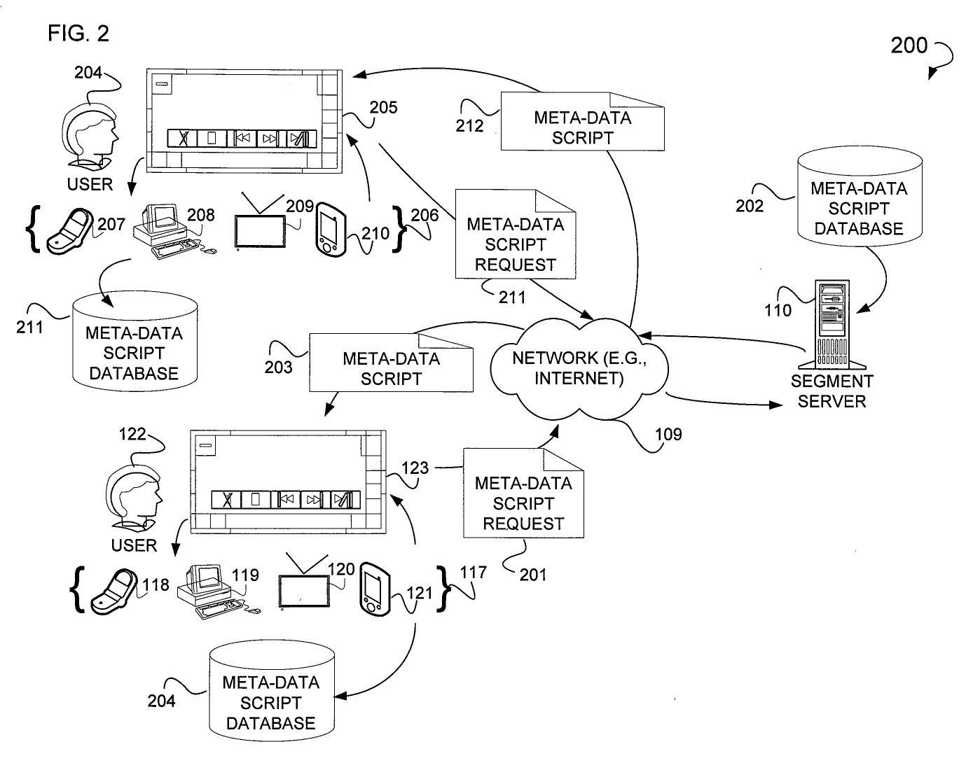

FIG. 2 is a diagram of an example system 200 used to aggregate a number of metadata scripts, and to provide these scripts to multiple requesting users. In some example embodiments, the segment server 110 may serve an aggregating function so as to aggregate the metadata scripts (see e.g., metadata scripts 203 and 212), and to serve up these aggregating scripts to one or more client devices (e.g., the one or more devices 117 or 206). Shown is the previously illustrated user 101 who, using the one or more devices 103, may generate a metadata script request 201. This metadata script request 201 may be transmitted using HTTP and may be generated using an XML based message. Also shown is a user 204 who using one or more devices 206 may generate the metadata script request 211. These one or more devices 206 may include a cell phone 207, computer system 208, television 209, or PDA 210. The user 204 may use a GUI 205 to generate the metadata script request 211. The GUI 205 may be generated by the one or more devices 206. The metadata script request 211 may be transmitted using HTTP and XML as illustrated above.

In some example cases, the segment server 110 may retrieve a metadata script 203 or 212 from a metadata script database 202. This metadata script 203 may be transmitted by the segment server 110 back across network 109 to be received by the one or more devices 103. The metadata script 212 may be transmitted by the segment server 110 back across network 109 to be received by the one or more devices 206. This metadata script 203 or 212 may be transmitted using HTTP. Operatively coupled to the one or more devices 103 may be a metadata script database 204, where the metadata script 203 may be stored for future use. Operatively coupled to the one or more devices 206 may be a metadata script database 211, where the metadata script 212 may be stored for future use. This metadata script database 204 or 211 may be a native database (e.g., one that resides on the one or more devices 103 or 206), or may be a non-native database. In cases where the metadata script database 204 or 211 is non-native, the metadata script database 204 or 211 may be managed by an intermediate database server.

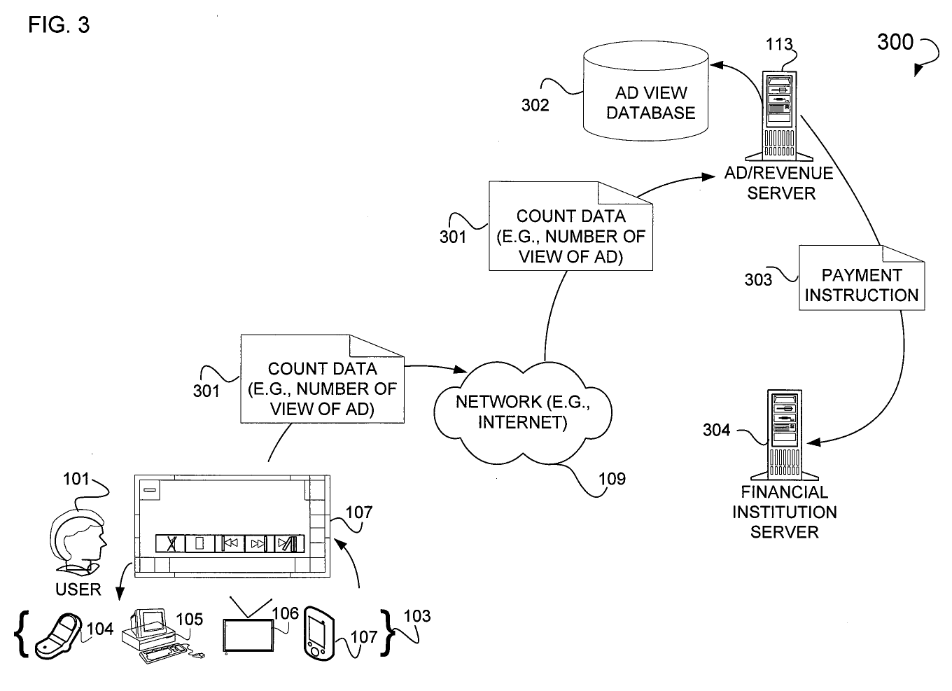

FIG. 3 is diagram of an example system 300 illustrating the generation of count data and the crediting of a user 101 for this count data. In some example embodiments, the user 101 may use the one or more computer systems 103 to view one or more segment and advertisements 115. While viewing a segment and advertisement 115, the one or more devices 103 may record the number of times the advertisement 114, associated with the segment that is part of the segment and advertisement 115, has been viewed by the user 101. At certain predetermined times (e.g., periodic or event-driven times), count data 301 may be generated and transmitted by the one or more devices 103 across the network 109 to be received by the ad/revenue server 113. This count data may be transmitted using HTTP or HTTPS and may include the number of views of the advertisement 114 that have occurred. Views may include the serving of a web page by a web server of the segment and advertisement 115. Operatively coupled to the ad/revenue server 113 is an ad view database 302. This ad view database 302 may be used to store the count data 301. In some example embodiments, based on this count data 301, the ad/revenue server 113 may generate and transmit a payment instruction 303 to be received by a financial institution server 304. This payment instruction 303 may be transmitted using HTTPS. Included within this payment instruction 303 may be an instruction to credit a financial institution account that is owned, controlled, or otherwise used by the user 101. This payment instruction 303 may instruct the financial institution server 304 to credit the account owned, controlled, or used by the user 101 with a particular monetary amount based on the count data 301.

### Example Interfaces

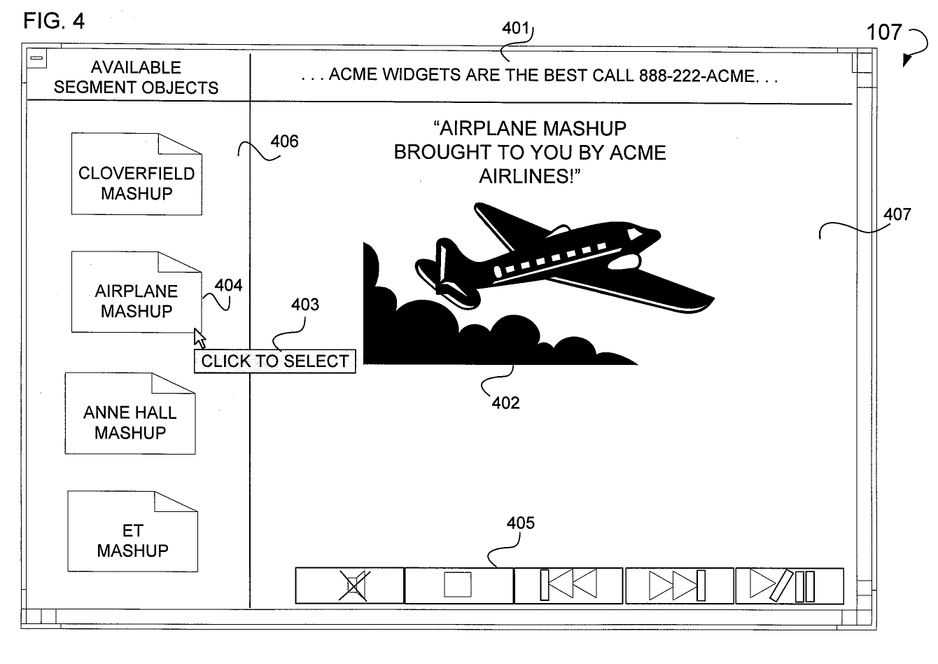

FIG. 4 is an example GUI 107 used to display the segment and advertisement 115. Shown is a GUI 107 including a sub-frame 401, a sub-frame 406, and a sub-frame 407. With regard to the sub-frame 401, a banner advertisement is shown within this sub-frame 401. With regard to the sub-frame 406, a number of available segment objects are displayed within the sub-frame 406. For example, an Airplane mashup 404 is shown. As to the sub-frame 407, an advertisement 402 is shown (e.g., is shown as playing) within the sub-frame 407 that may correspond to the advertisement 114. Also shown within the sub-frame 407 is a content control toolbar 405 that allows the user 101 to various media player instructions such as pause, fast forward, play, reverse, mute, and perform other functions or operations with regard to the segment. As referenced elsewhere, the segment may be a video segment, an audio segment, or an audio/video segment. Further, shown is a mouse pointer 403, and functionality associated with this mouse pointer 403. For example, using a mouse pointer 403, a user 101 may be able to click on (e.g., perform a mouse-based click operation on) the Airplane mashup 404. This Airplane mashup 404 may be a screen object or widget graphically representing the segment and advertisement 115. In some example embodiments, some other type of functionality may be associated with a mouse pointer. This functionality may be used to execute a segment and advertisement 115 as displayed via a screen object or widget (e.g., the Airplane mashup 404). For example, a mouse over operation may be used, a left click operation may be used, a keyboard operation may be used, or some other suitable operation may be used.

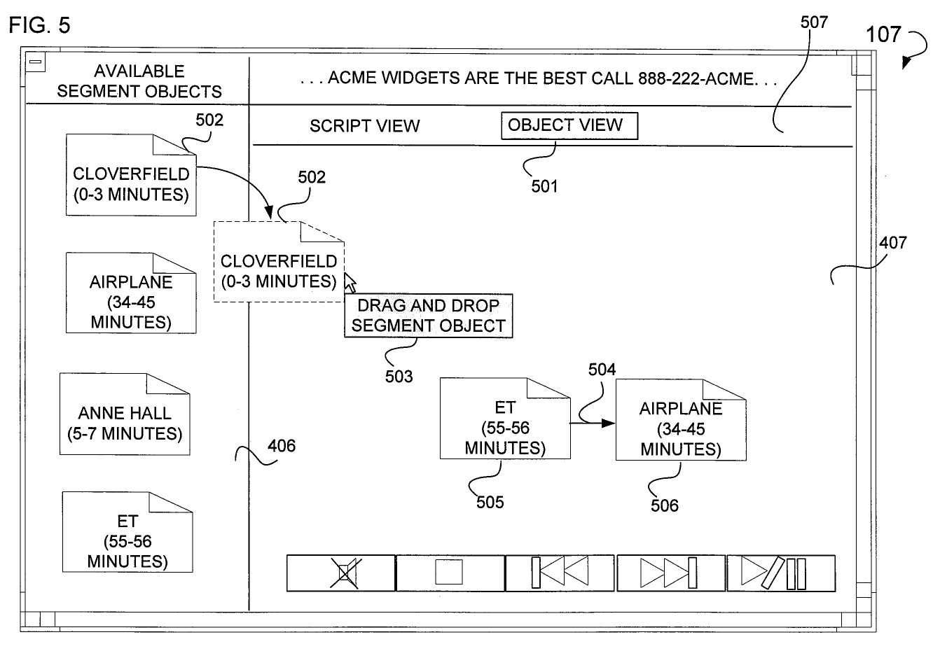

FIG. 5 is an example GUI 107 used to generate a mashup using linked screen objects or widget. Shown is the sub-frame 406, wherein the sub-frame 406 includes a number of segments (e.g., audio/video segments). For example, a segment 502 is shown with a title of Cloverfield, wherein the first three minutes of Cloverfield are included within this segment. Cloverfield may be the title of a type of long-form content in the form of a movie. Using a mouse pointer 503 and associated functionality, the Cloverfield segment 502 may be dragged and dropped into the sub-frame 407. Once dragged and dropped to the sub-frame 407, the mouse pointer 503 may be used to link the Cloverfield segment 502 to other segments illustrated within the sub-frame 407. These other segments including the ET segment 505 and the Airplane segment 506 are linked via a link 504. ET and Airplane may be the respective titles of a type of long-form content in the form of movies. Using these links, as illustrated by link 504, various segments may be combined to form a mashup. Sub-frame 407 shows screen objects or widgets representing various segments such as segments 502, 505, and 506 that are linked. These screen objects or widgets may be viewed through the execution of a further screen object or widget 501 that resides within the sub-field 507. The screen object or widget 501, when executed, allows for an object view of objects used to generate a mashup.

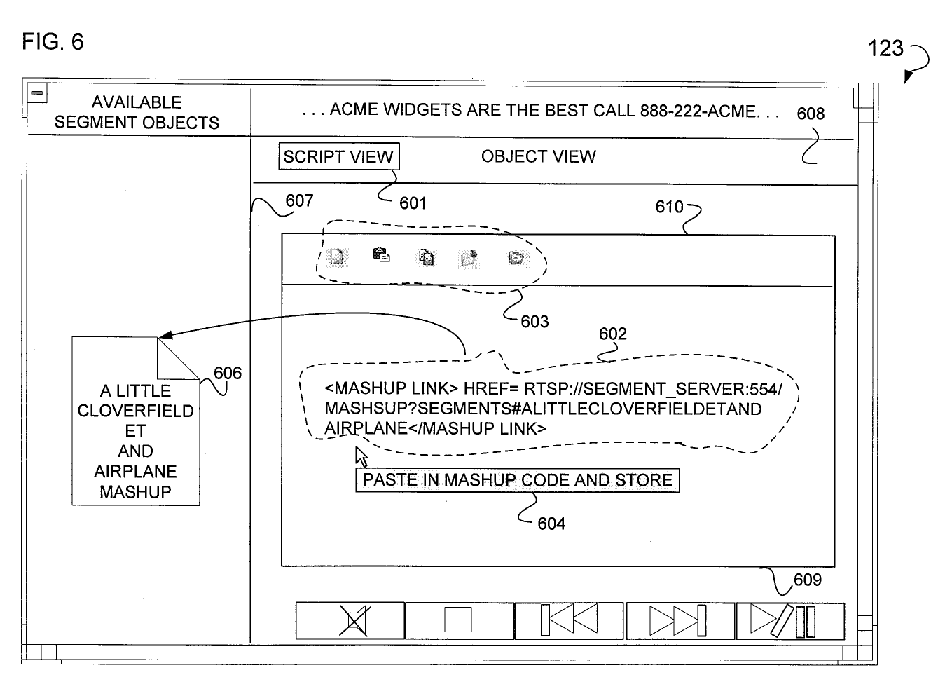

FIG. 6 is an example GUI 123 that may be used to generate a derivative content item in the form of a mashup using an instruction set written as a script. Included as a part of this GUI 123 is a sub-frame 607 that includes available segment objects generated using this GUI 123. Also shown as a sub-frame 608 that includes a screen object or widget 601 that allows for a user, such as user 122, to have a script view of the script used to generate a mashup. Also shown is a sub-frame 610 that includes various screen objects or widgets that allow for the editing of the script used to generate the mashup. This editing may be represented via various screen objects or widgets in the form of editing tools (collectively referenced as 603) to facilitate copying, pasting, cutting and other functionality (e.g., editing functionality) commonly associated with the editing of a script in a development environment. Also is shown is a sub-frame 609 that displays a script used to generate a mashup. In some example embodiments, a virally distributed segment 116 may be pasted into the sub-frame 609 using a mouse pointer 604 and the functionality associated therewith. This functionality may include a copy and paste function whereby the user 122 may copy instructions written in a scripting language that are displayed as part of a webpage controlled or used by the user 101. Instructions, referenced herein as 602, may be copied into the sub-frame 609 and stored as a segment object 606. Further, these instructions 602 may be included as part of the virally distributed segment 116. Here, the segment 606 is titled: “A Little Cloverfield, ET and Airplane” mashup.

In some example embodiments, the mashups may be posted to a web page using the GUI 107 or GUI 123. Some example embodiments include posting the various linked segments (e.g., the Cloverfield segment 502, ET segment 505 and the Airplane segment 506) to a web page for viewing as a mashup. Further, in some example embodiments, instruction 602 may be posted to a web page as a mashup. In cases where instruction 602 is used to post a mashup, instruction 602 may be interpreted by a web browser to generate a human readable representation of the mashup. This human readable representation may be as a screen object or widget. A web page, as referenced herein, may reside on a server executing a social network application. Each view of the mashup posted to the web page may be recorded as count data 301.

### Example Logic

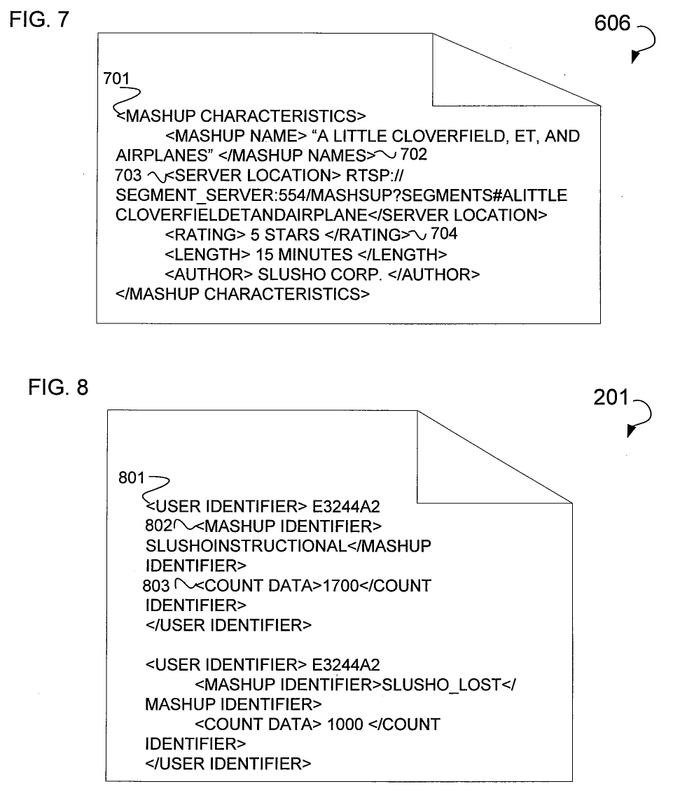

FIG. 7 is an example derivative content item 606 and a scripting language representation thereof. Shown is a mash 606 represented in scripting language form. A field 701 is shown that denotes the characteristics of this mashup script. These characteristics may include a mashup name, a rating for a mashup, a length of the mashup, and an author of the mashup. Further, a field 702 is shown that illustrates a mashup name which here is: “A Little Cloverfield, ET, and Airplane.” Further, a field 703 is shown that illustrates a server location for a particular mashup. Here, the server location may be referenced using RTSP. Further, a field 704 illustrates rating information for a particular mashup, which here is a five star rating.

FIG. 8 is a diagram of an example metadata script request 201. Shown, for example, is a metadata script request 201 and the various data fields associated with this metadata script request. For example, a field 801 is shown as including a user identifier. Further, a field 802 is shown illustrating a mashup identifier. Additionally, field 803 is shown illustrating account data. With regard to field 801, the user identifier may be some type of Globally Unique Identifier (GUID), or other identifier used to uniquely identify a particular user such as user 101. Further, the field 802 may reference a particular mashup identifier where this mashup identifier may be a string-based identifier, a GUID identifier, or some other identifier that uniquely identify a particular mashup. Further, the field 803 may include count data when this count data relates to how many times a particular metadata script has been requested by a user 101.

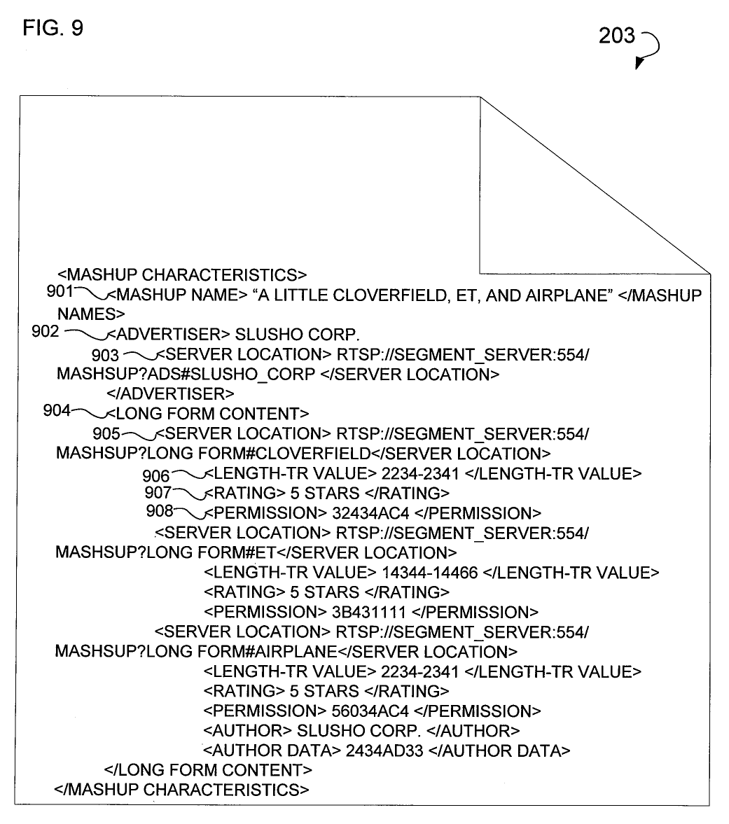

FIG. 9 is a diagram of an example metadata script 203. Shown is a metadata script 203 including a number of fields. For example, a field 901 is illustrated that includes the name of a particular mashup which here is: “A Little Cloverfield, ET, and Airplane.” Further, field 902 is shown that displays information relating to the advertisement associated with the segment. Here, for example, field 902 displays the advertiser name, which is: “Slusho Corporation.” Additionally, field 903 is shown that includes server location information for the particular advertisement for the advertiser illustrated in field 902. Here, for example, the sever location is referenced as an RTSP server. Also shown is a field 904 that illustrates the long-form content and the segment that is to be associated with the particular advertisement.

In some example embodiments, portions or segments of long-form content may be assembled together into a mashup and then associated with an advertisement for viewing. Here, for example, a field 905 references a server location for particular segment with the segment may be retrieved using RSTP and, further, the segment is the Cloverfield segment (see e.g., Cloverfield segment 502). Further, field 906 illustrates the length of the segment which here is referenced as a Temporal Reference (TR) value for an MPEG-based file. Other type of temporal reference values for other types of codecs may also be used. Additionally, field 907 illustrates a rating associated with the segment, which here is five stars. Moreover, a field 908 illustrates a permission associated with the segment where this permission is referenced as a hexadecimal value of 32434AC4. In some example embodiments, the field 908 and permissions associated therewith may be permissions based on copyrights wherein copyrights may include the right to publish, distribute, publicly display, the right to creative derivative works, and others rights commonly understood as copyrights.

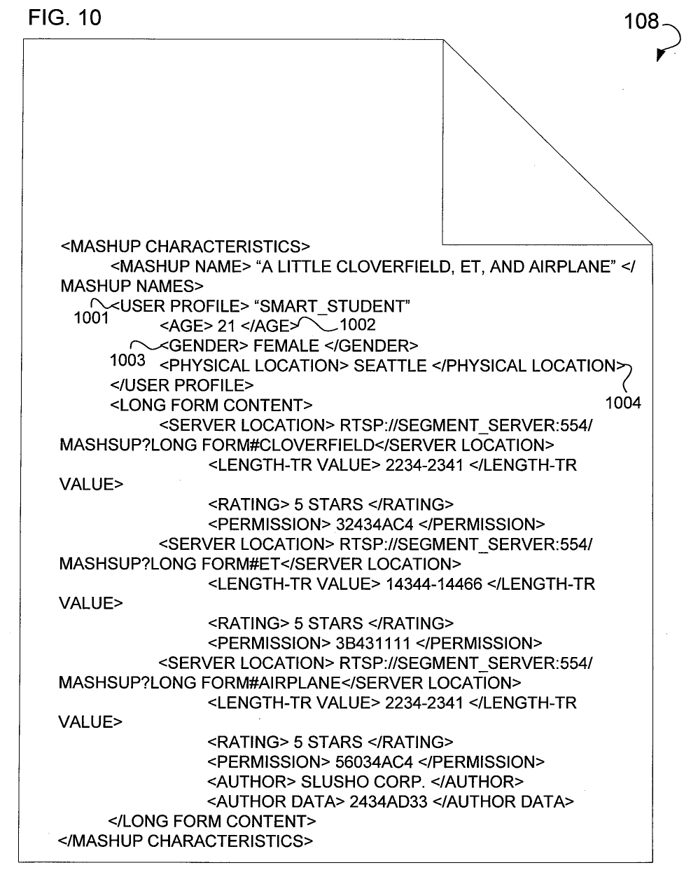

FIG. 10 is a diagram of an example segment request 108. Shown is a segment request 108 including a number of fields. In some example embodiments, a segment request 108 may include information identifying the requested segment (e.g., the segment of the long-form content) alone, or in combination with demographic information relating to the profile (e.g., user profile) of the user generating the segment request 108. A user may be user 122 or user 204. Illustrated is a field 1001 denoting a user's profile. This field may include an online identifier such as a user handle common to many social networking website. A field 1002 is also shown illustrating the age of the user. Field 1003 illustrates the gender of the user. Field 1004 illustrates the physical location of the user (e.g., where the user is domiciled). The data includes in fields 1001-1004 may be used to determine the type of advertisement that may be provided with the segment and advertisement 115. The advertisement may be based, in part, upon the data included within these fields.

In some example embodiments, the field 1001 may include user specific metadata. For example, a user may include metadata as part of the field 1001 that illustrates the user particular likes and dislikes such as colors, types of cars, travel destinations, universities, sports teams, sports, movies, songs, video, and other types of metadata describing information unique to them. This user specific metadata may then be used as the basis upon which to associate an advertisement with a segment as outlined below.

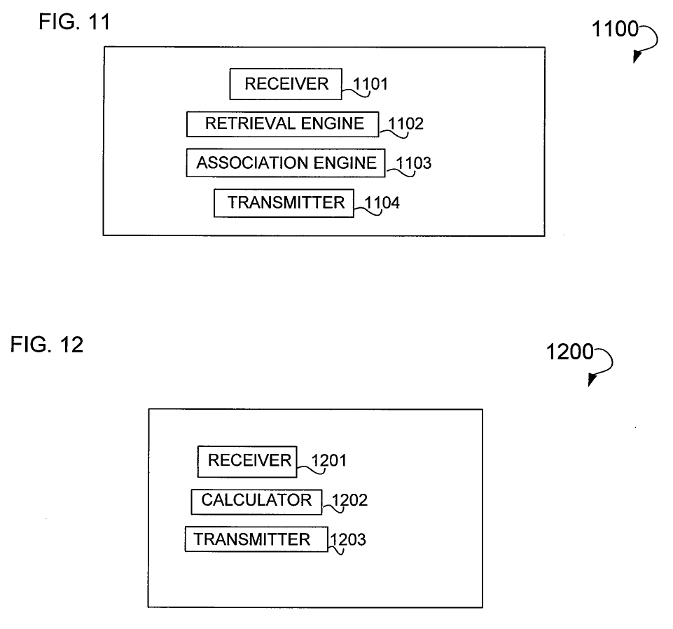

FIG. 11 is a block diagram of an example computer system 1100. This example computer system 1100 may be the one or more devices 103, or segment server 110. The blocks shown herein may be implemented in hardware, firmware, or software. Illustrated is a receiver 1101 to receive a segment request including a reference to a segment of a content item. Further, a retrieval engine 1102 is shown to retrieve an advertisement to be associated with the segment. An association engine 1103 is shown to associate the segment and the advertisement to form a derivative content item. A transmitter 1104 is illustrated to transmit the derivative content item. In some example embodiments, the content item comprises long-form content including at least one of a movie, full-length television program, or a song. Further, in some example embodiments, the association engine 1103 may associate a plurality of segments retrieved from a plurality of distinct long-form content sources, and the advertisement, to form the derivative content item. Additionally, the derivative content item includes a metadata script. Moreover, the transmitter 1104 may transmit the metadata script for distribution as a virally distributed segment. The receiver 1101 may receive a media player instruction and performing a player action responsive to the media player instruction.

FIG. 12 is a block diagram of an example computer system 1200. This example computer system 1200 may be the one or more devices 103, or segment server 110. The blocks shown herein may be implemented in hardware, firmware, or software. Shown is a receiver 1201 to receive count data including a number of times an advertisement included in a derivative content item has been accessed, the advertisement being combined with a segment of a content item to form the derivative content item. Further, a calculator 1202 is shown to calculate a payment amount based on the count data. A transmitter 1203 is shown to transmit a payment instruction including the payment amount. In some example embodiments, the term accessed includes displayed on a web page, or otherwise served up by a web server. Further, the term mashup may include a plurality of segments retrieved from a plurality of distinct long-form content sources.

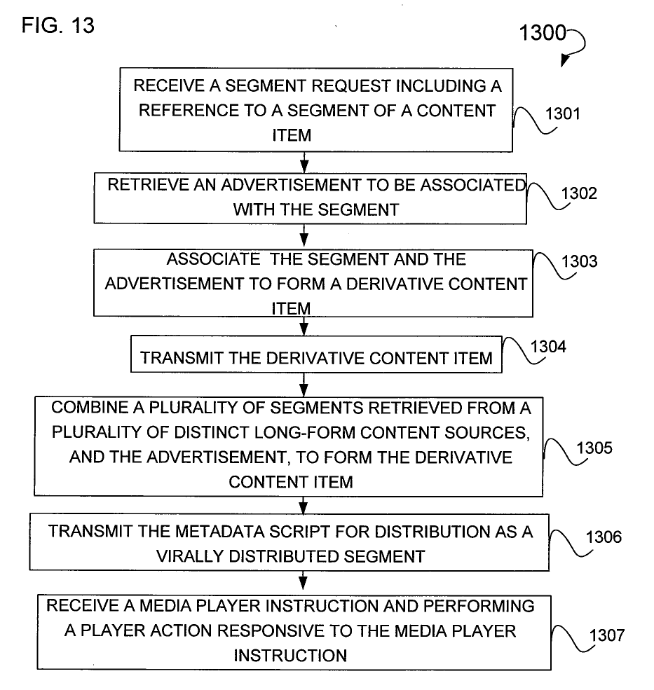

FIG. 13 is flow chart illustrating the execution of a method 1300 to transmit a mashup. This method 1300, and the operations associated therewith (e.g., operations 1301-1306), is executed by the segment server 103, or the one or more devices 103. An operation 1301 is shown that, when executed, receives a segment request including a reference to a segment of a content item. Further, an operation 1302 is shown, that when executed, retrieves an advertisement to be associated with the segment. An operation 1303 is illustrated, that when executed, associates the segment and the advertisement to form a derivative content item. An operation 1304 is shown that, when executed, transmits the derivative content item. In some example embodiments, the content item comprises long-form content including at least one of a movie, full-length television program, or a song. An operation 1305, when executed, combines a plurality of segments retrieved from a plurality of distinct long-form content sources, and the advertisement, to form the derivative content item. In some example embodiments, the derivative content item includes a metadata script. An operation 1306, when executed, transmits the metadata script for distribution as a virally distributed segment. An operation 1307, when executed, receives a media player instruction and performs a player action responsive to the media player instruction. In some example embodiments, the derivative content item includes a plurality of segments retrieved from a plurality of distinct long-form content sources.

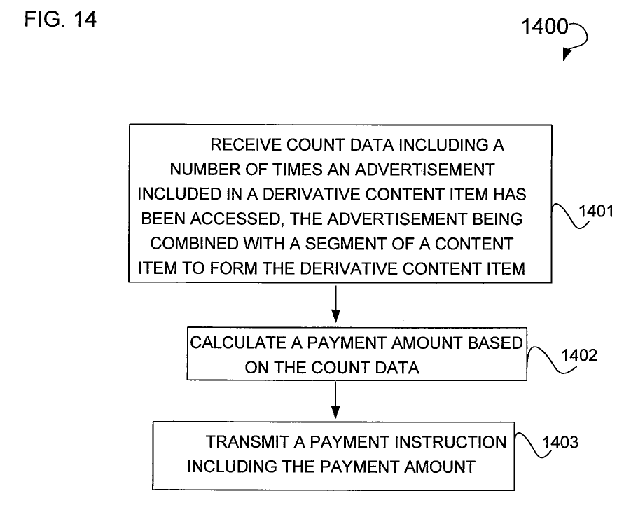

FIG. 14 is a flow chart illustrating an example method 1400 used to transmit payment instructions. This method 1400, and the operations associated therewith (e.g., operations 1401-1403), is executed by the segment server 103, or the one or more devices 103. An operation 1401, when executed, may receive count data including a number of times an advertisement included in a derivative content item has been accessed, the advertisement being combined with a segment of a content item to form the derivative content item. An operation 1402, when executed, may calculate a payment amount based on the count data. An operation 1403, when executed, may transmit a payment instruction including the payment amount. In some example embodiments, the term accessed includes displayed on a web page, other otherwise served up by a web server. In some example embodiments, the term mashup includes a plurality of segments retrieved from a plurality of distinct long-form content sources.

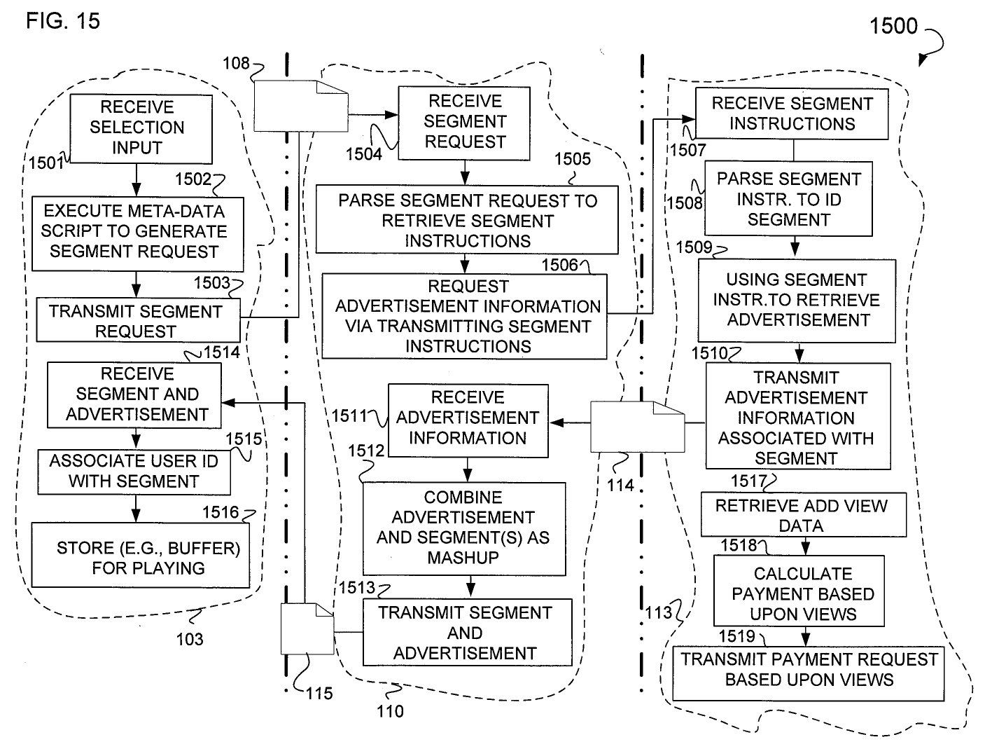

FIG. 15 is a tri-stream flowchart illustrating a method 1500, according to an example embodiment, of generating the segment and advertisement 115. Shown is a first stream of the tri-stream flowchart including operations 1501-1503 and operations 1514-1516. These various operations may reside on and be executed by the one or more devices 103. Further, shown is a second stream including operations 1504-1506 and 1511-1513. These various operations are executed by the segment server 110. A third stream is shown including operations 1507-1510, and operations 1517-1519. These various operations are executed by the ad/revenue server 113.

Starting with the one or more devices 103, and the various operations associated therewith, an operation 1501 is executed that may receive selection input. This selection input may be a mouse-over operation, a right-click operation, or some other suitable operation that may be used to execute a screen object or widget residing as a part of the GUI 107. An operation 1502 is executed that, when executed, may execute a metadata script used to generate a segment request 108. This metadata script, as previously illustrated, may be an instruction set written using, for example, XML, HTML, ActionScript, Perl, JavaScript, VBScript, or some other suitable scripting language. An operation 1503 is executed that may transmit a segment request 108, where the segment request 108 may be received through the execution of the operation 1504 executed by the segment server 110. An operation 1505 is executed that may parse the segment request to retrieve segment instructions. An operation 1506 is executed that may request advertisement information associated with the segment referenced by the segment instructions. In some example embodiments, segment information derived from the segment instructions may be transmitted through the execution of operation 1506. The operation 1507 residing as a part of the ad/revenue server 113 is executed that may receive the segment instructions. An operation 1508 is executed that may parse the segment instructions to obtain a segment identifier. An operation 1509 is executed that may retrieve an advertisement using the segment identifier, where this advertisement is retrieved from some type of advertisement database (not shown). An operation 1510 is executed that transmit advertisement information associated with the segment as an advertisement 114. An operation 1511 residing as a part of, for example, segment server 110 (e.g., or executed by the segment server 110) is executed to receive the advertisement 114. An operation 1512 is executed that may combine the advertisement and segment with other segments as a mashup. In some example embodiments, the combination of the advertisement and one segment may form a mashup. An operation 1513 is executed to transmit the segment and advertisement as the segment and advertisement 115 to be received through the execution of an operation 1514. An operation 1515 is executed that may associate a user ID with a segment and an operation where the user ID may uniquely identify the user 101 or even the user 122. An operation 1516 is executed that may store the segment and advertisement 115 (e.g., store into a buffer) for playing within the previously illustrated sub-frame 407.

In some example embodiments, the operation 1509 may use the user metadata to retrieve an advertisement. This operation 1509 may make a Structured Query Language (SQL) query (e.g., a “SELECT” command) of a database including advertisements uniquely identified by one or more key values. These key values may, in turn, be based upon advertisements predetermined by a long-form content owner (e.g., the copyright owner, or licensee), distributor, or other suitable person to be associated with a particular segment ID. Advertisements may then be selected/retrieved based upon this segment ID.

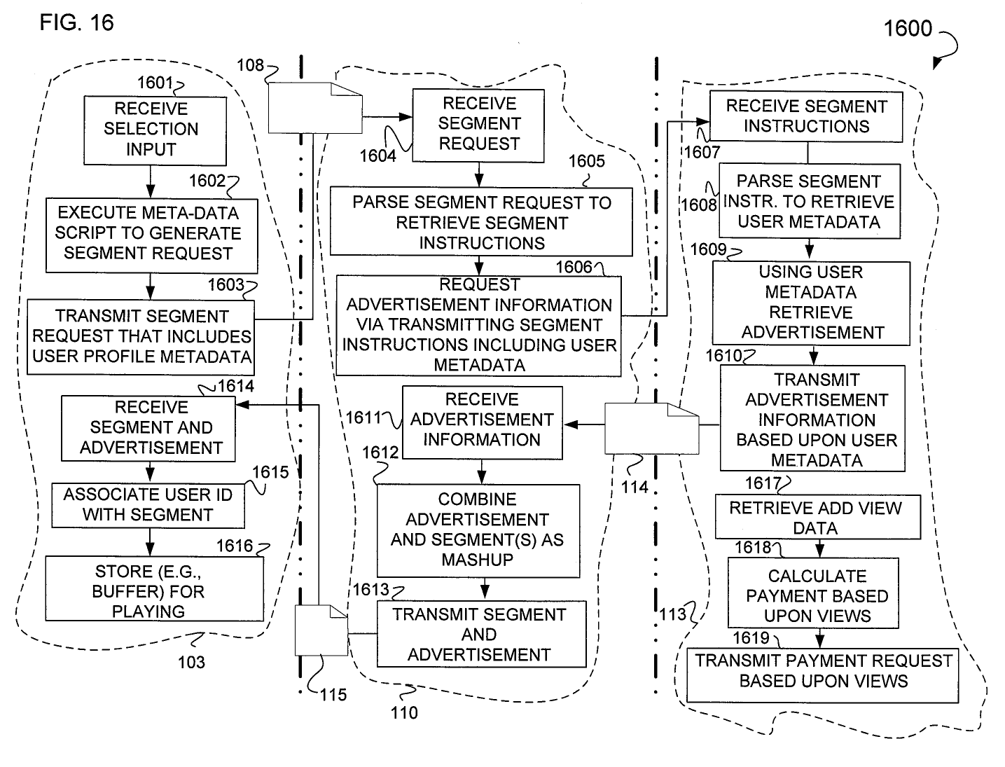

FIG. 16 is a tri-stream flowchart illustrating a method 1600, according to an example embodiment, of generating the segment and advertisement 115, the advertisement based upon user profile metadata. Shown is a first stream of the tri-stream flowchart including operations 1601-1603 and operations 1614-1616. These various operations may reside on and be executed by the one or more devices 103. Further, shown is a second stream including operations 1604-1606 and operations 1611-1613. These various operations are executed by the segment server 110. A third stream is shown including operations 1607-1610, and operations 1617-1619. These various operations are executed by the ad/revenue server 113.

Beginning with the one or more devices 103, and the various operations associated therewith, an operation 1601 is executed that may receive selection input. This selection input may be a mouse-over operation, a right-click operation, or some other suitable operation that may be used to execute a screen object or widget residing as a part of the GUI 107. An operation 1602 is executed that, when executed, may execute a metadata script used to generate a segment request 108. This metadata script, as previously illustrated, may be an instruction set written using XML, HTML, ActionScript, Perl, JavaScript, VBScript, or some other suitable scripting language. An operation 1603 is executed that may transmit a segment request 108, where the segment request 108 may include user profile metadata relating to a user's demographic. This segment request 108 may be received through the execution of the operation 1604 executed by the segment server 110. An operation 1605 is executed that may parse the segment request to retrieve segment instructions. An operation 1606 is executed that may request advertisement information associated with the segment referenced by the segment instructions. These segment instructions may include user metadata such as the user profile metadata illustrated above. In some example embodiments, segment information derived from the segment instructions may be transmitted through the execution of operation 1606. The operation 1607 residing as a part of the ad/revenue server 113 is executed that may receive the segment instructions. An operation 1608 is executed that may parse the segment instructions to obtain the user metadata. An operation 1609 is executed that use the user metadata to retrieve an advertisement from some type of advertisement database (not shown). An operation 1610 is executed is executed that transmits advertisement information based upon the user metadata associated with the segment as an advertisement 114. An operation 1611 residing as a part of segment server 110 (e.g., or executed by the segment server 110) is executed to receive the advertisement 114. An operation 1612 is executed to combine the advertisement and segment with other segments as a mashup. In some example embodiments, the combination of the advertisement and one segment may form a mashup. An operation 1613 is executed to transmit the segment and advertisement as the segment and advertisement 115 to be received through the execution of an operation 1614. An operation 1615 is executed that may associate a user ID with a segment and an operation where the user ID may uniquely identify the user 101 or even the user 122. An operation 1616 is executed that may store the segment and advertisement 115 (e.g., store into a buffer) for playing within the previously illustrated sub-frame 407.

In some example embodiments, the operation 1609 may use the user metadata to retrieve an advertisement. This operation 1609 may make a SQL query (e.g., a “SELECT” command) of a database including advertisements uniquely identified by one or more key values. These key values may, in turn, be based upon a combination of one or more of the user metadata elements (see e.g., field 1001-1004) as determined by an advertiser. Advertisements may then be selected/retrieved based upon the user metadata. In some example embodiments, user metadata elements (e.g., user specific metadata) specific to the user may be used to retrieve an advertisement.

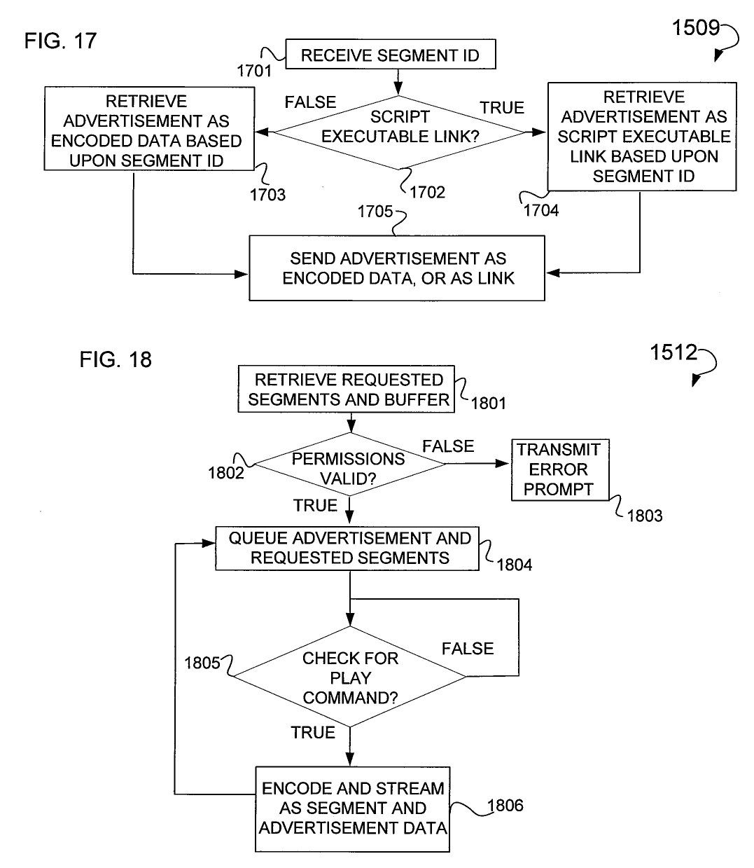

FIG. 17 is a flow chart illustrating the example operation 1509. Shown is an operation 1701 that when executed, receives a segment identifier. A decisional operation 1702 is executed that determines whether or not a script executable link is thought to be retrieved as the basis for displaying an advertisement such as advertisement 402 within the sub-frame 407. In cases where decisional operation 1702 evaluates to “false,” an operation 1703 is executed. When executed, operation 1703 may retrieve an advertisement as encoded data based on a segment ID. In some example embodiments, encoded data may be data encoded using an MPEG, H.261-H.264, VP6, or other suitable encoding regime. In cases where decisional operation 1702 evaluates to “true,” an operation 1704 is executed that may retrieve an advertisement as a script executable link based on the segment ID. The script executable link may be a link written in HTML, XML, or some other suitable markup language. An operation 1705 is executed that may send the advertisement as encoded link in the form of an advertisement 114.

FIG. 18 is a flowchart illustrating an example execution of operation 1512. Shown is an operation 1801 that when executed, retrieves a requested segment and buffer. This buffer may be some type of non-persistent memory store that may be used to temporarily save the segment and associated advertisement. In some example embodiments, the decisional operation 1802 is executed that may determine whether or not the permissions for a particular user such as user 101 are valid for the purposes of playing or otherwise displaying the segment and advertisement 115 within the sub-frame 407. In cases where decisional operation 1802 evaluates to “false,” operation 1803 is executed that may transmit an error prompt. This error prompt may state that a user, such as the user 101, is not entitled to view a particular segment or advertisement based on their lack of permissions to do so. In other example embodiments, these permissions may relate to other permissions associated with the aforementioned copyrights. In cases where decisional operation 1802 evaluates to “true,” an operation 1804 is executed. This operation 1804, when executed, may queue up an advertisement and requested segments for playing by the GUI 107 and, more specifically, within the sub-frame 407.

In some example embodiments, a decisional operation 1805 is executed that may determine whether or not a play command has been received. In some example embodiments, this play command may be a play command generated using RTSP. Further, in some example cases, other types of commands may be determined as to whether they have been executed by the user 101. These other types of commands may include a pause command, forward command, a reverse command, or some other suitable command associated with the RTSP as executed by the user 101. In cases where decisional operation 1805 evaluates to “false,” the operation 1805 is re-executed. In cases where decisional operation 1805 evaluates to “true,” an operation 1806 is executed. When executed, operation 1806 may encode and stream the segment advertisement 115 to be received by the user 101 using one or more devices 103.

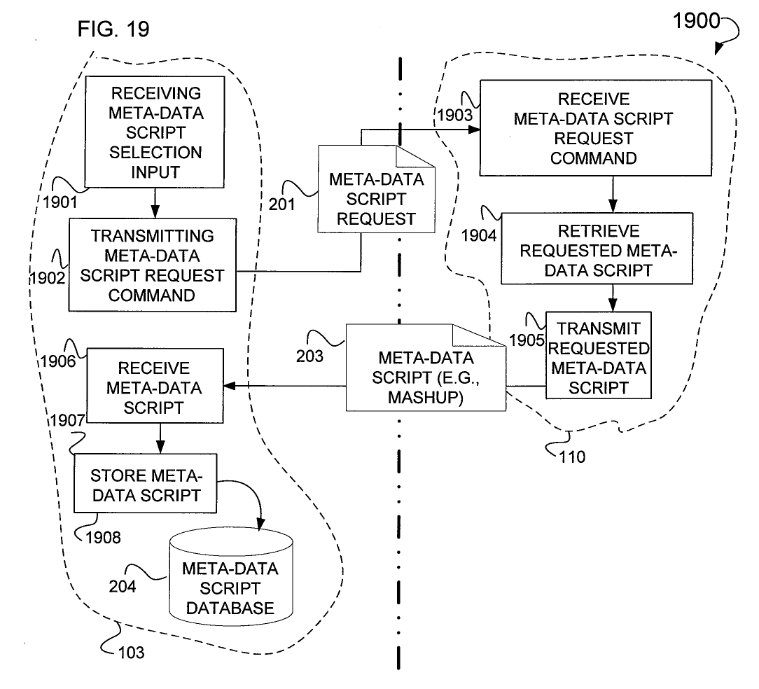

FIG. 19 is a dual-stream flowchart illustrating the generation of a metadata script as a result of a metadata script request 201. Shown is a first stream including operations 1901-1902 and operations 1906-1908. These various operations are executed by the one or more devices 103. Also shown is a second stream including operations 1903-1905. These various operations are executed by the segment server 110. In some example embodiments, an operation 1901 is executed that may receive metadata script selection input. This metadata script selection input may be in the form of some type of mouse-based operation or functionality such as a right-click operation, mouse-over operation, or some other suitable mouse-based operation. An operation 1902 is executed that may transmit a metadata script request command in the form of the metadata script request 201. An operation 1903 is executed to receive the metadata script request command. An operation 1904 is executed that retrieves a metadata script based on the metadata script request 201. An operation 1905 is executed to transmit the requested metadata script 203. This metadata script may be retrieved from the previously illustrated metadata script database 202. Upon the execution of operation 1905, a metadata script 203 may be transmitted that includes instructions used to generate display a mashup within the sub-frame 407. This mashup may be the previously shown Airplane mashup 404. An operation 1906 is executed to receive the metadata script 203. An operation 1907 is executed to store the metadata script into the previously illustrated metadata script database 204. In some example embodiments, operations 1903-1905 are executed by the one or more devices 103.

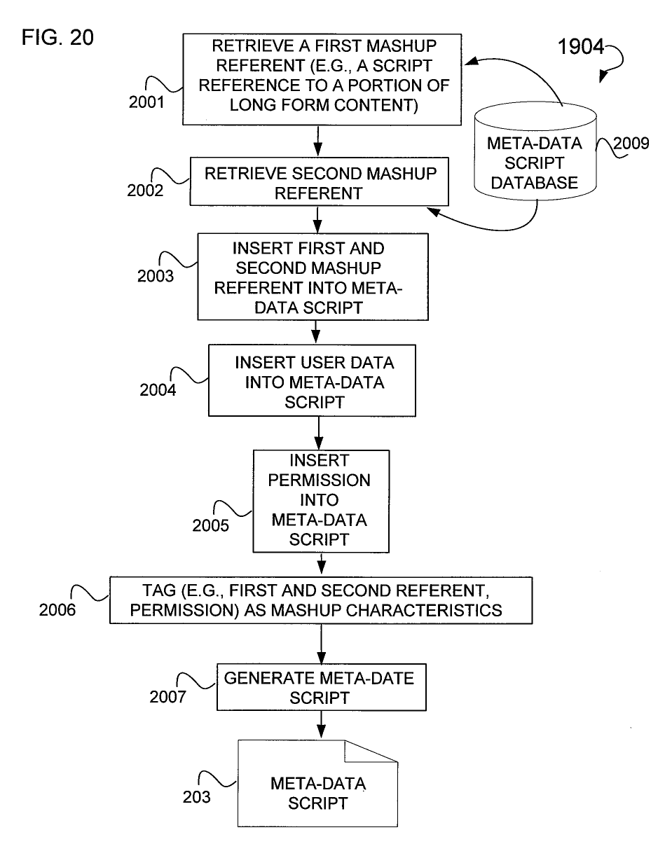

FIG. 20 is a flowchart illustrating the example execution of operation 1904. Shown is an operation 2001 that, when executed, may retrieve a first mashup referenced from a metadata script database 2009. In some example embodiments, metadata script database 2009 may be akin to metadata script database 202. An operation 2002 is executed that may retrieve a second mashup reference from the metadata script database 2009. In some example embodiments, a mashup reference may be some type of scripted web link (e.g., an href-based link), or some other suitable script based reference. An operation 2003 is executed that may insert the first or second mashup into a metadata script. Further, an operation 2004 is executed that may insert user data into the metadata script, wherein this user data may be some uniquely identifying value associated with the user (e.g., the user 101). An operation 2005 is executed that may insert a permission into a metadata script where this permission may be a permission included in the previously referenced permission field 908. An operation 2006 is executed that may tag the first and second reference permissions as mashup characteristics as may be illustrated in the field 905. An operation 2007 is executed that may actually generate a metadata script using some type of predefined scripting template as determined by an XML Schema Definition (XSD), Document Type Definition (DTD), or some other suitable type scripting template. As used herein, a referent is a reference such as a thing being referenced.

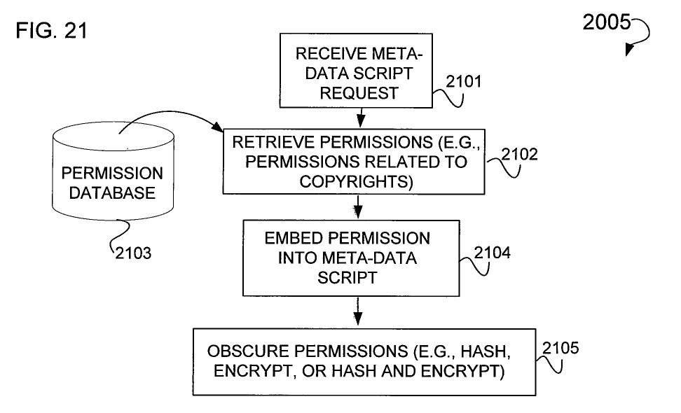

FIG. 21 is a flow chart illustrating the example execution of operation 2005. Shown is an operation 2101 that when executed may receive a metadata script request. An operation 2102 is executed to retrieve permissions (e.g. permissions associated with various copyrights) from a permissions database 2103. An operation 2104 is executed to embed the permissions into metadata script. These permissions may be embedded into the previously illustrated field 908. Also shown is an operation 2105 that may obscure the permissions using some type of obscuring regime such as hashing and encrypting or some other suitable combination of hashing and encrypting. Hashing may be performed using the Message-Digest algorithm 5 (MD-5), Secure Hash Algorithm-1 (SHA-1), or some other suitable hashing algorithm. In some example embodiments, encrypting may be performed using some type of symmetric or asymmetric encryption regime. This symmetric or asymmetric encryption regime may include the Advanced Encryption Standard (AES), Rivest, Shamir, and Adleman (RSA), or some other suitable symmetric or asymmetric encryption regime.

### Example Database

Some embodiments may include the various databases (e.g., 111, 202, 204, 302, 2009, 2103) being relational databases, or, in some cases, Online Analytic Processing (OLAP)-based databases. In the case of relational databases, various tables of data are created and data is inserted into and/or selected from these tables using SQL or some other database-query language known in the art. In the case of OLAP databases, one or more multi-dimensional cubes or hyper cubes, including multidimensional data from which data is selected from or inserted into using a Multidimensional Expression (MDX) language, may be implemented. In the case of a database using tables and SQL, a database application such as, for example, MYSQL™, MICROSOFT SQL SERVER™, ORACLE 8I™, 10G™, or some other suitable database application may be used to manage the data. In this, the case of a database using cubes and MDX, a database using Multidimensional Online Analytic Processing (MOLAP), Relational Online Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, or optimization algorithm known in the art.

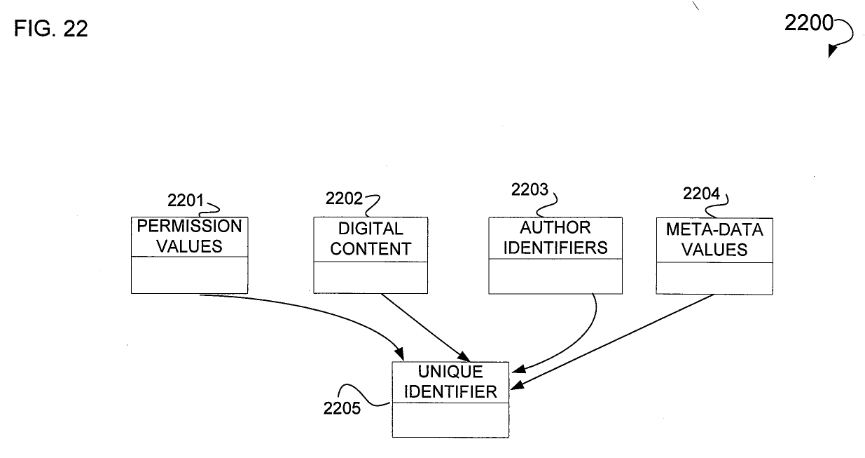

FIG. 22 is an example RDS 2200. Illustrated are a number of tables that may be used to generate an RDS. For example, a table 2201 is shown that includes permission values where these permissions values may be integer values represented in decimal, hexadecimal, octal, or some other suitable form. These permissions values may be stored as an integer, string, Binary Large Object (BLOB), or some other suitable data type. Table 2202 is shown that includes digital content. This digital content may be long-form content in the form of MPEG, or VP6 encoded content stored as a BLOB data type. Also shown is a table 2203 that includes author identifier information. This author identifier information may be some type of unique identifier such as a GUID that may be used to uniquely identify an author of a particular mashup, or segment used to generate portion of a mashup. An integer, string, or other suitable data type may be used to store the data included within table 2203. Table 2204 may include various metadata values and/or scripts. This metadata may include user profile metadata, metadata relating to a mashup, an advertisement, or some other suitable metadata. An XML data type, BLOB data type, or other suitable data type may be used to store this metadata values and/or script. Table 2205 may include unique identifiers to uniquely identify each of the data or tuple entries for each of the tables 2201-2204. An integer or other suitable data type may be used to store the data included within table 2205.

### Component Design

Some example embodiments may include the above-illustrated operations being written as one or more software components. These components, and the functionality associated with each, may be used by client, server, or peer computer systems. These various components can be implemented into the system on an as-needed basis. These components may be written in an object-oriented computer language such that a component oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM)), or other suitable technique. These components are linked to other components via various Application Programming Interfaces (APIs) and then compiled into one complete server and/or client application. The method for using components in the building of client and server applications is well known in the art. Further, these components may be linked together via various distributed programming protocols as distributed computing components.

### Distributed Computing Components and Protocols

Some example embodiments may include remote procedure calls being used to implement one or more of the above-illustrated components across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

A System of Transmission between a Server and Client

Some embodiments may use the Open Systems Interconnection (OSI) model, or Transmission Control Protocol/Internet Protocol (TCP/IP) protocol stack model for defining the protocols used by a network to transmit data. In applying these models, a system of data transmission between a server and client, or between peer computer systems, is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also includes port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as the Internet, LAN, WAN, or some other suitable network. In some cases, Internet refers to a network of networks. These networks may use a variety of protocols for the exchange of data, including the aforementioned TCP/IP, or some other suitable protocol. These networks may be organized within a variety of topologies (e.g., a star topology) or structures.

### A Computer System

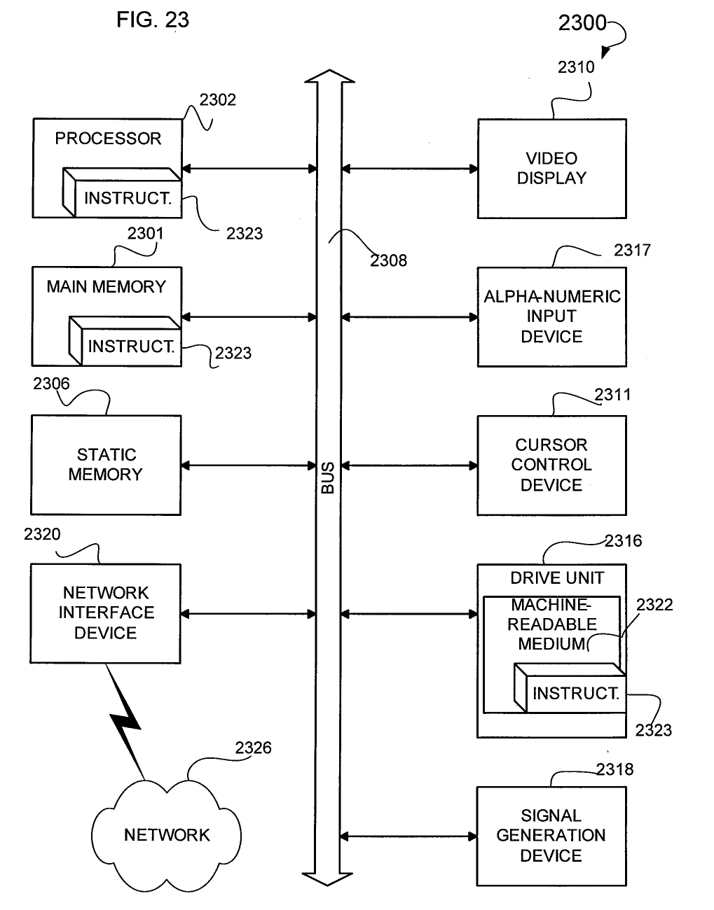

FIG. 23 shows a diagrammatic representation of a machine in the example form of a computer system 2300 that executes a set of instructions to perform any one or more of the methodologies discussed herein. A server is a computer system. In alternative embodiments, the machine operates as a stand-alone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 2300 includes a processor 2302 (e.g., a CPU, a Graphics Processing Unit (GPU) or both), a main memory 2301, and a static memory 2306, which communicate with each other via a bus 2308. The computer system 2300 may further include a video display unit 2310 (e.g., a Liquid Crystal Display (LCD) or a Cathode Ray Tube (CRT)). The computer system 2300 also includes an alphanumeric input device 2317 (e.g., a keyboard), a UI cursor controller 2311 (e.g., a mouse), a drive unit 2316, a signal generation device 2318 (e.g., a speaker) and a network interface device (e.g., a transmitter) 2320.

The disk drive unit 2316 includes a machine-readable medium 2322 on which is stored one or more sets of instructions and data structures (e.g., software) 2321 embodying or used by any one or more of the methodologies or functions illustrated herein. The software instructions 2321 may also reside, completely or at least partially, within the main memory 2301 and/or within the processor 2302 during execution thereof by the computer system 2300, the main memory 2301 and the processor 2302 also constituting machine-readable media.

The instructions 2321 may further be transmitted or received over a network 2326 via the network interface device 2320 using any one of a number of well-known transfer protocols (e.g., HTTP, HTTPS).

The term “machine-readable medium” should be taken to include a single medium or multiple media (e.g., a centralized or distributed database, and/or associated caches and servers) that store the one or more sets of instructions. The term “machine-readable medium” shall also be taken to include any medium capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

### Marketplace Applications

In some example embodiments, a system and method is shown that pursuant to the grant of certain copyright permissions allows for the creation various mashup of digital content. These mashups include advertisements. Further, these mashups may be virally distributed among users for playing. These mashup may be scripts that allow for digital content to be retrieved for playing. In certain example cases, a user may be compensated monetarily for posting mashup to a web site or web page for playing.

In some example embodiments, the system and method as illustrated herein may be used to validate documents, where the authentication of the content of the document and the author of the document may be required. This document may be a university transcript, birth certificate, or other suitable document.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
receiving a segment request including a reference to a segment of a content item that represents less than an entirety of the content item;
retrieving an advertisement based on a segment identifier obtained from the segment request, the advertisement being retrievable from a database based on the segment identifier of the segment of the content item;
forming a derivative content item by combining, using one or more processors, the segment of the content item and the advertisement; and
transmitting the derivative content item.

2. The computer implemented method of claim 1, wherein the content item comprises long-form content including at least one of a movie, full-length television program, or a song.

3. The computer implemented method of claim 1, further comprising combining a plurality of segments retrieved from a plurality of distinct long-form content sources, and the advertisement, to form the derivative content item.

4. The computer implemented method of claim 1, wherein the derivative content item includes a metadata script.

5. The computer implemented method of claim 4, further comprising transmitting the metadata script for distribution as a virally distributed segment.

6. The computer-implemented method of claim 1, further comprising receiving a media player instruction and performing a player action responsive to the media player instruction.

7. The computer implemented method of claim 1 further comprising:
receiving count data including a number of times the advertisement included in the derivative content item has been accessed;
calculating a payment amount based on the count data; and
transmitting a payment instruction including the payment amount.

8. The computer implemented method of claim 8, wherein accessed includes displayed on a web page.

9. The computer implemented method of claim 7, wherein the derivative content item includes a plurality of segments retrieved from a plurality of distinct long-form content sources.

10. A computer system comprising:
a receiver to receive a segment request including a reference to a segment of a content item that represents less than an entirety of the content item;
a retrieval engine to retrieve an advertisement based on a segment identifier obtained from the segment request, the advertisement being retrievable from a database based on the segment identifier of the segment of the content item;
an association engine to form a derivative content item by combining the segment and the advertisement; and
a transmitter to transmit the derivative content item.

11. The computer system of claim 10, wherein the content item comprises long- form content including at least one of a movie, full-length television program, or a song.

12. The computer system of claim 10, wherein the association engine associates a plurality of segments retrieved from a plurality of distinct long-form content sources, and the advertisement, to form the derivative content item.

13. The computer system of claim 10, wherein the derivative content item includes a metadata script.

14. The computer system of claim 13, wherein the transmitter transmits the metadata script for distribution as a virally distributed segment.

15. The computer system of claim 10, wherein the receiver receives a media player instruction and performing a player action responsive to the media player instruction.

16. The computer system of claim 10, wherein the receiver is further to receive count data including a number of times the advertisement included in the derivative content item has been accessed, the computer system further comprising;
a calculator to calculate a payment amount based on the count data; and
a transmitter to transmit a payment instruction including the payment amount.

17. The computer system of claim 16, wherein accessed includes displayed on a web page.

18. The computer system of claim 16, wherein the derivative content item includes a plurality of segments retrieved from a plurality of distinct long-form content sources.

19. An apparatus comprising:
means for receiving a segment request including a reference to a segment of a content item that represents less than an entirety of the content item;
means for retrieving an advertisement based on a segment identifier obtained from the segment request, the advertisement being retrievable from a database based on the segment identifier of the segment of the content item;
means for forming a derivative content item by combining the segment of the content item and the advertisement; and
means for transmitting the derivative content item.

20. A non-transitory machine-readable medium comprising instructions, which when implemented by one or more machines, cause the one or more machines to perform operations comprising:
receiving a segment request including a reference to a segment of a content item that represents less than an entirety of the content item;
retrieving an advertisement based on a segment identifier obtained from the segment request, the advertisement being retrievable from a database based on the segment identifier of the content item;
forming a derivative content item by combining the segment of the content item and the advertisement; and
transmitting the derivative content item.
